(19) United States
(12) Patent Application Publication
(10) Pub. No.: US 2015/0028505 A1
(43) Pub. Date: Jan. 29, 2015

(54) MOLD RELEASABILITY EVALUATING APPARATUS AND MOLD RELEASABILITY EVALUATION METHOD

(71) Applicant: TOYOTA JIDOSHA KABUSHIKI KAISHA, Toyota-shi (JP)

(72) Inventor: Ikuo YAMAUCHI, Chiryu-shi (JP)

(73) Assignee: TOYOTA JIDOSHA KABUSHIKI KAISHA, Toyota-shi (JP)

(21) Appl. No.: 14/326,594

(22) Filed: Jul. 9, 2014

(30) Foreign Application Priority Data
Jul. 29, 2013 (JP) 2013-156315

(51) Int. Cl. B29C 45/76; B22C 9/00; B22D 46/00; B29C 37/00

(52) U.S. Cl. CPC B29C 45/7626; B29C 37/0003; B22C 9/00; B22D 46/00; B29C 2037/90
USPC 264/40.1; 425/444; 164/150.1; 164/4.1

(57) ABSTRACT

A mold releasability evaluating apparatus includes a forming die that includes a bottom portion having a main surface, and a wall surface portion that is connected to the main surface of the bottom portion and has a wall surface in which an angle formed with the main surface of the bottom portion is an obtuse angle; an extrusion pin capable of protruding out from the main surface of the bottom portion in a direction that separates a compact from the main surface of the bottom; and a measuring device configured to measure a load applied to the extrusion pin when the extrusion pin pushes the compact away from the main surface of the bottom portion, after one surface of the compact is formed by the main surface of the bottom portion.

### INCORPORATION BY REFERENCE

The disclosure of Japanese Patent Application No. 2013-156315 filed on Jul. 29, 2013 including the specification, drawings and abstract is incorporated herein by reference in its entirety.

### BACKGROUND OF THE INVENTION

1. Field of the Invention

The invention relates to a mold releasability evaluating apparatus and a mold releasability evaluation method.

2. Description of Related Art

One known forming method obtains a compact of a desired shape by hardening liquid or slurry in a forming die. With this kind of forming method, a mold release agent is applied to the forming die in order to facilitate release of the compact from the mold. Therefore, a mold release agent evaluating apparatus for evaluating the ease of mold-releasability by the mold release agent is used.

For example, Japanese Patent Application Publication No. 2005-009971 (JP 2005-009971 A) describes a mold release agent evaluating apparatus that measures tensile force while pulling a compact in a direction parallel to an upper main surface thereof, after forming one surface of the compact by an upper main surface of a plate body that represents a forming die. This kind of mold release agent evaluating apparatus measures the tensile force when the compact starts to move as a mold release resistance force, and is able to easily evaluate the mold releasability by the mold release agent based on this tensile force.

The measurement accuracy of the mold release resistance force changes depending on the shape of the compact.

For example, there is a compact 80 formed between a fixed die 85 and a movable die 86, as shown in FIG. 16A. The movable die 86 separates from the fixed die 85 and the compact 80, as shown in FIG. 16B. Further, the compact 80 is extruded in an extrusion direction E1 by extrusion pins 83, and consequently released from the mold, as shown in FIG. 16C. Here, a parallel surface 81 of the compact 80 that is parallel to the extrusion direction E1 has a larger area than a perpendicular surface 82 of the compact 80 that is perpendicular to the extrusion direction E1 does. The mold release agent evaluating apparatus described in JP 2005-009971 A is able to measure, with good accuracy, the mold release resistance force of a compact that has a shape in which the area of the parallel surface 81 is greater than the area of the perpendicular surface 82, like the compact 80.

On the other hand, there is a compact 90 formed between a fixed die 95 and a movable die 96, as shown in FIG. 17A. Just as with the compact 80, the movable die 96 separates from the fixed die 95 and the compact 90, as shown in FIG. 17B. Further, the compact 90 is extruded in an extrusion direction E2 by extrusion pins 93, and consequently released from the mold, as shown in FIG. 17C. Unlike with the compact 80, a perpendicular surface 92 of the compact 90 that is perpendicular to the extrusion direction E2 has a larger area than a parallel surface 91 of the compact 90 that is parallel to the extrusion direction E2 does. The mold release agent evaluating apparatus described in JP 2005-009971 A is unable to measure, with good accuracy, the mold release resistance force of a compact that has a shape in which the area of the perpendicular surface 92 is greater than the area of the parallel surface 91, like the compact 90.

### SUMMARY OF THE INVENTION

The invention thus provides a mold releasability evaluating apparatus and a mold releasability evaluation method capable of measuring a mold release resistance force with good accuracy.

A first aspect of the invention relates to a mold releasability evaluating apparatus. The mold releasability evaluating apparatus includes (i) a forming die that includes a bottom portion having a main surface, and a wall surface portion that is connected to the main surface of the bottom portion and has a wall surface in which an angle formed with the main surface of the bottom portion is an obtuse angle; (ii) an extrusion pin capable of protruding out from the main surface of the bottom portion in a direction that separates a compact from the main surface of the bottom; and (iii) a measuring device configured to measure a load applied to the extrusion pin when the extrusion pin pushes the compact away from the main surface of the bottom portion, after one surface of the compact is formed by the main surface of the bottom portion.

With this kind of structure, it is possible to measure the mold release resistance force with good accuracy.

A second aspect of the invention relates to a mold releasability evaluation method that includes a first step of forming, using the mold releasability evaluating apparatus described above, the one surface of the compact with the main surface of the bottom portion; a second step of pushing the compact away from the main surface of the bottom portion by the extrusion pin; and a third step of measuring the load applied to the extrusion pin in the second step.

With this kind of structure, it is possible to measure the mold release resistance force with good accuracy.

The mold releasability evaluation method may also include a fourth step of separating the compact from the wall surface portion by the compact shrinking, between the first step and the second step. The mold releasability evaluation method may also include a fifth step of applying a mold release agent to the main surface of the bottom portion before the first step.

According to the invention, a mold releasability evaluating apparatus and a mold releasability evaluation method that measure a mold release resistance force with good accuracy are able to be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a plan view of a mold releasability evaluating apparatus according to a first example embodiment of the invention;

FIG. 2 is a sectional view of the mold releasability evaluating apparatus according to the first example embodiment;

FIG. 3 is a flowchart of a mold releasability evaluation method according to the first example embodiment;

FIG. 4 is a view showing a frame format of the mold releasability evaluation method according to the first example embodiment;

FIG. 5 is a view showing another frame format of the mold releasability evaluation method according to the first example embodiment;

FIG. 6 is a view showing another frame format of the mold releasability evaluation method according to the first example embodiment;

FIG. 7 is a view showing another frame format of the mold releasability evaluation method according to the first example embodiment;

FIG. 8 is a view showing another frame format of the mold releasability evaluation method according to the first example embodiment;

FIG. 9 is a view showing another frame format of the mold releasability evaluation method according to the first example embodiment;

FIG. 10 is a view showing a frame format of one example of the mold releasability evaluating apparatus according to the first example embodiment;

FIG. 11 is a view showing a frame format of another example of the mold releasability evaluating apparatus according to the first example embodiment;

FIG. 12 is a graph illustrating an extrusion load over time;

FIG. 13 is a plan view of one example of the mold releasability evaluating apparatus according to the first example embodiment;

FIG. 14 is a plan view of another example of the mold releasability evaluating apparatus according to the first example embodiment;

FIG. 15 is a plan view of yet another example of the mold releasability evaluating apparatus according to the first example embodiment;

FIGS. 16A to 16C are views showing frame formats of a related die casting method; and

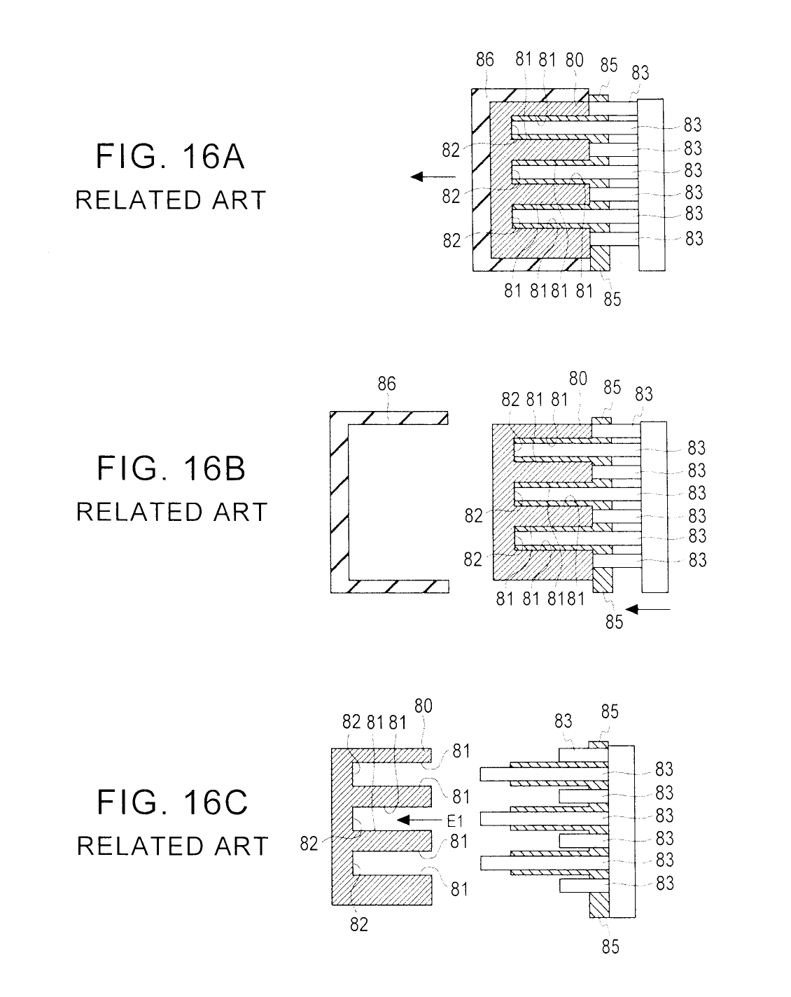

FIGS. 17A to 17C are views showing frame formats of a related die casting method.

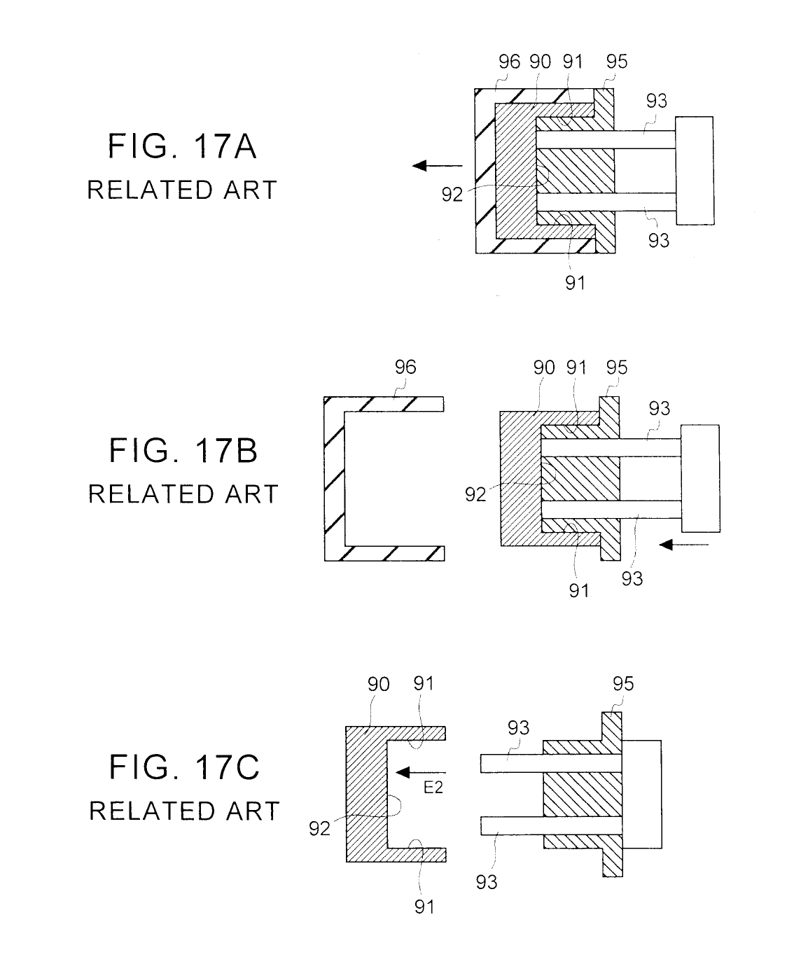

### DETAILED DESCRIPTION OF EMBODIMENTS

### First Example Embodiment

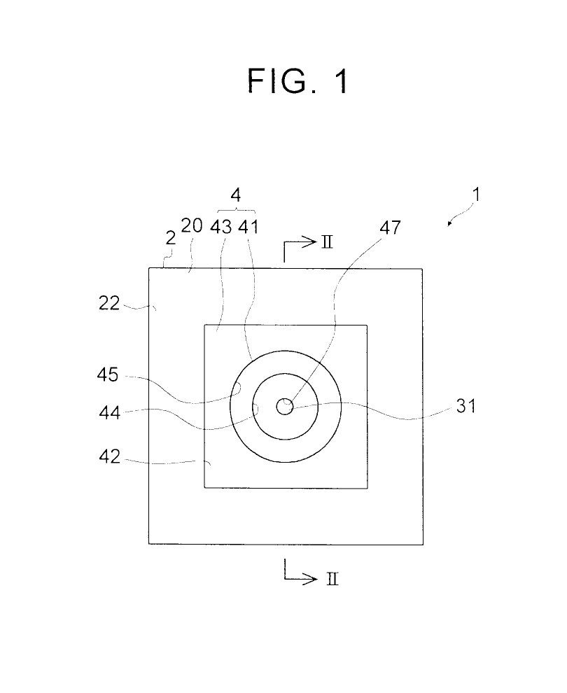

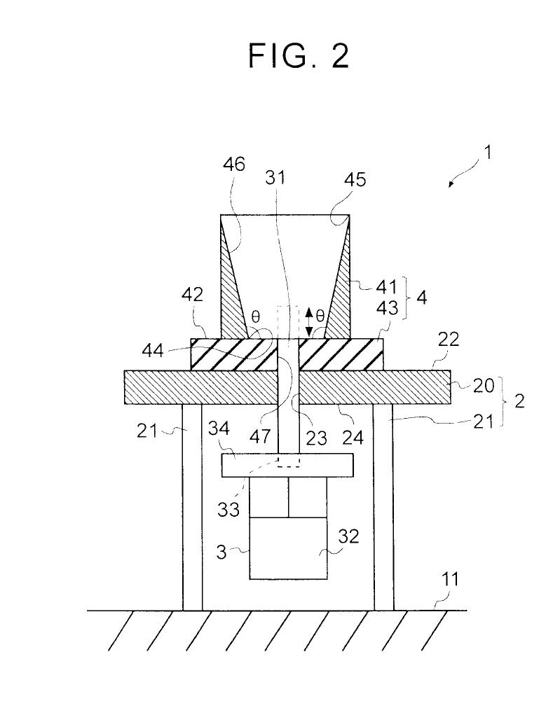

A mold releasability evaluating apparatus according to a first example embodiment of the invention will now be described with reference to FIGS. 1 and 2. FIG. 1 is a plan view of the mold releasability evaluating apparatus according to the first example embodiment. FIG. 2 is a sectional view of the mold releasability evaluating apparatus according to the first example embodiment.

As shown in FIGS. 1 and 2, the mold releasability evaluating apparatus 1 includes a holder 2, an extrusion mechanism 3, and a forming die 4. The mold releasability evaluating apparatus 1 simulates the phenomenon of a compact being released from a mold, and is able to measure a load applied to an extrusion pin. The mold releasability evaluating apparatus 1 is then able to evaluate mold releasability based on the measurement value of this load. In this specification, mold releasability refers to the ease with which a compact is released from a mold. Factors of mold releasability include, for example, the material of the compact, the amount of mold release agent, the application method of mold release agent, the material, surface properties, and surface treatment film of the mold, the number, shape, material, and operating method of extrusion pins, the material, surface properties, and surface treatment film of a mold member such as a core pin, and the amount of sleeve lubricant and the application method thereof.

The holder 2 includes a retainer plate 20 and supporting legs 21. The retainer plate 20 is a rectangular plate that has the mechanical strength necessary to hold the forming die 4 and a compact F. A passage hole portion 23 that is open to enable an extrusion pin 31 to pass through is located near the center of an upper main surface 22 of the retainer plate 20. The supporting legs 21 are a plurality of column-shaped bodies that extend from four corners of the retainer plate 20 to a mounting surface 11 of the mold releasability evaluating apparatus 1. The supporting legs 21 position the retainer plate 20 at a predetermined height, and support the retainer plate 20 along a horizontal plane.

The extrusion mechanism 3 includes the extrusion pin 31, an extruding portion 32, a load measuring portion 33, and an extrusion plate 34. The extrusion mechanism 3 is located below a lower main surface 24 of the retainer plate 20.

The extrusion pin 31 is supported by the extrusion plate 34. A tip end of the extrusion pin 31 is aligned with an upper end of the passage hole portion 23. The extrusion pin 31 is preferably made of the same type of material as an extrusion pin used under actual release conditions to evaluate mold releasability, and is preferably the same or similar shape as this extrusion pin.

The extruding portion 32 uses pneumatic pressure or hydraulic pressure or the like as the power source, and operates the extrusion pin 31 so that it is pushed upwards through the extrusion plate 34. The extruding portion 32 may also be fixed to the supporting legs 21 or the mounting surface 11.

The load measuring portion 33 is located between the extrusion pin 31 and the extrusion plate 34, and is able to measure the load applied to the extrusion pin 31. A load cell, for example, may be used as the load measuring portion 33. The load measuring portion 33 is connected to an information processing device, not shown, and transmits a signal regarding a measured load value. The information processing device stores information regarding the measured load value, and outputs the information regarding the measured load value to an output portion such as a display, so that a user of the mold releasability evaluating apparatus 1 is able to check it.

The forming die 4 is mounted on the upper main surface 22 of the retainer plate 20. The forming die 4 serves to hold and harden a liquid or slurry. The forming die 4 includes a plate-like die 43, and a cylindrical die 41. The plate-like die 43 is a bottom portion of the forming die 4. Also, the cylindrical die 41 is a wall surface portion of the forming die 4.

The plate-like die 43 is a rectangular plate made of metal material. A passage hole portion 47 that is open to enable the extrusion pin 31 to pass through is located near the center of the plate-like die 43. The plate-like die 43 is preferably made of the same type of metal material as the material of the mold used in the mold release conditions to evaluate mold releasability. A mold release agent used in the mold release conditions to evaluate mold releasability is preferably applied to an upper main surface 42 of the plate-like die 43.

The cylindrical die 41 is a cylindrical body made of metal material. The cylindrical die 41 has a truncated cone shaped cavity that is surrounded by an inner wall surface 46. A sectional area of this cavity increases from an open portion 44 of a lower end to an open portion 45 of an upper end. An angle 0 at which the inner wall surface 46 and the upper main surface 42 intersect is an obtuse angle, i.e., an angle that is greater than 90° and smaller than 180°. The cylindrical die 41 is mounted on the upper main surface 42 of the forming die 4. When the mold releasability evaluating apparatus 1 is viewed from above, the open portion 44 of the lower end surrounds the extrusion pin 31, as shown in FIG. 1. A mold release agent may also be applied to the inner wall surface 46.

(Mold Releasability Evaluation Method)

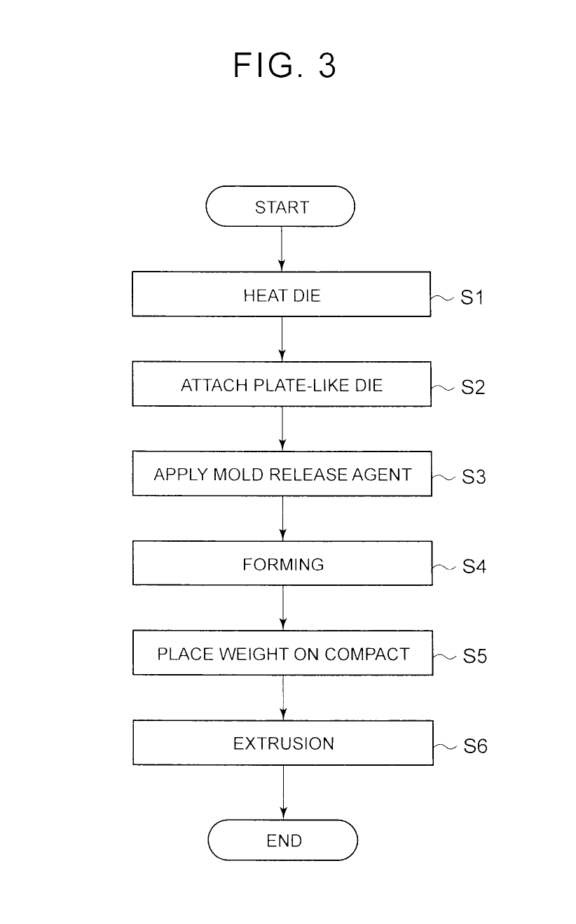

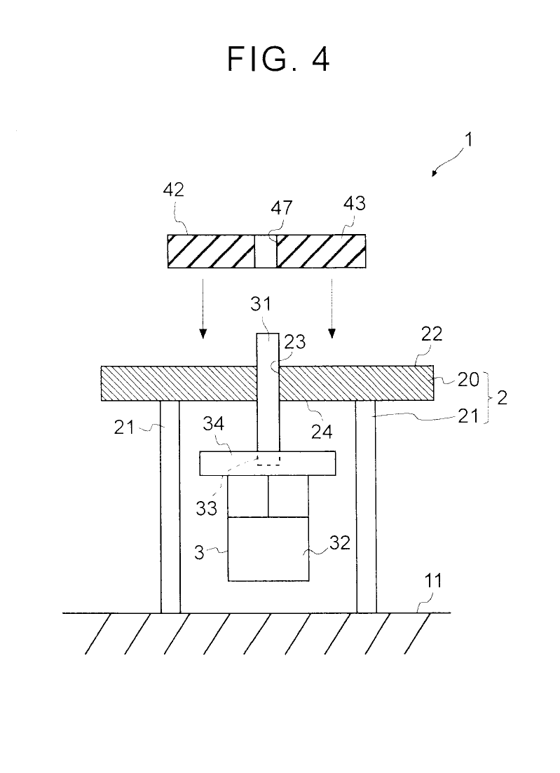

Next, a mold releasability evaluation method using the mold releasability evaluating apparatus according to the first example embodiment will be described with reference to FIGS. 4 to 9, along with FIG. 3. FIG. 3 is a flowchart of the mold releasability evaluation method according to the first example embodiment. FIGS. 4 to 9 are views showing frame formats of the mold releasability evaluation method according to the first example embodiment. Here, a case in which the purpose is to evaluate mold releasability by a mold release agent will be described as an example.

Before evaluating mold releasability, an evaluation item is determined, and the forming die 4 and the like matching the conditions of the specifications and this item is prepared. As described above, the evaluation item here is the mold release agent.

First, the plate-like die 43 is heated to a predetermined temperature (step S1). Here, a tip end portion of the extrusion pin 31 may be heated until the temperature thereof reaches the same temperature as the plate-like die 43. As a result, it is possible to inhibit the compact F from being formed wedged between the extrusion pin 31 and the plate-like die 43 in step S4 that will be described later, so a more accurate mold release resistance force is able to be obtained.

Continuing on, the plate-like die 43 is attached to the mold releasability evaluating apparatus 1, as shown in FIG. 4 (step S2). Then the plate-like die 43 is placed on the upper main surface 22 of the retainer plate 20, while the passage hole portion 47 is fitted over the tip end of the extrusion pin 31.

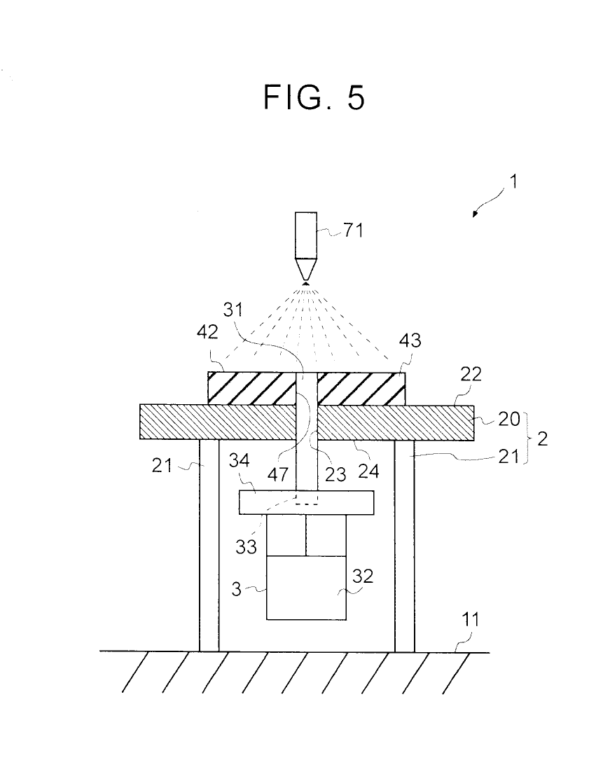

Then, the mold release agent to be evaluated is applied to the upper main surface 42 of the plate-like die 43 (step S3). For example, the mold release agent is sprayed toward the upper main surface 42 using a spray nozzle 71, as shown in FIG. 5. After the mold release agent is applied, air may be blown at the upper main surface 42 to remove any moisture remaining there if necessary.

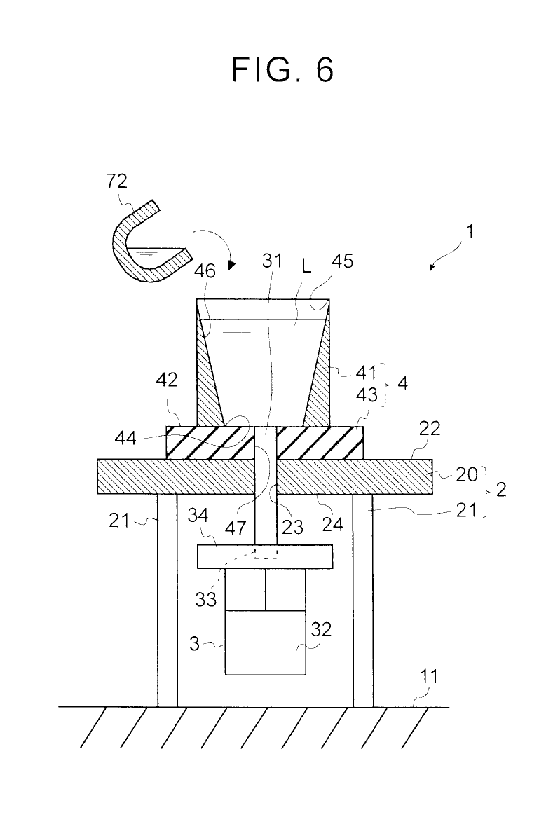

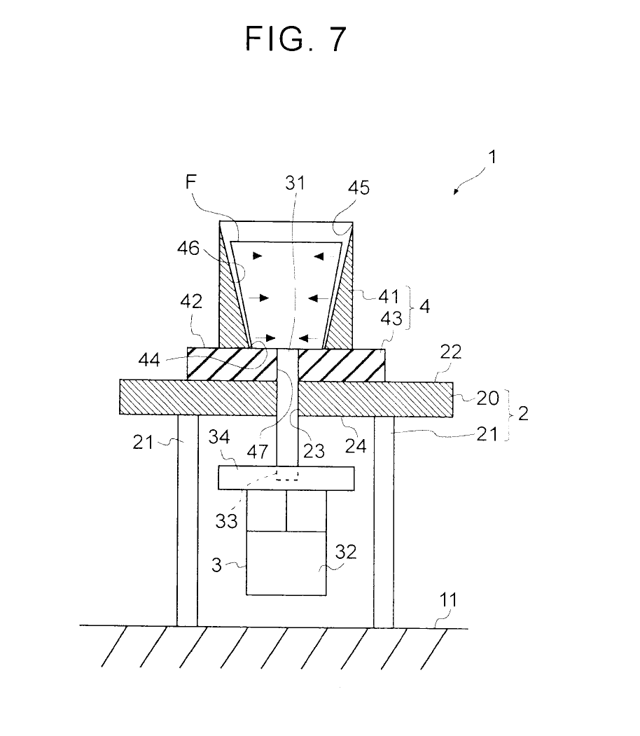

Continuing on, as shown in FIG. 6, the liquid or slurry is hardened on the surface of the plate-like die 43, such that one surface of the compact F (see FIG. 7) is formed by the upper main surface 42 (step S4). More specifically, the cylindrical die 41 is attached to the upper main surface 42 of the plate-like die 43. Then compact material that will form the compact F is heated or the like so that it is in a liquid or slurry state. This liquid or slurry compact material is then held in a vessel 72 and poured into the open portion 45 of the cylindrical die 41. The compact F is formed when the liquid or slurry hardens on the upper main surface 42 of the plate-like die 43, as shown in FIG. 7. The compact F is formed so as to separate from the inner wall surface 46 by solidification shrinkage and/or heat shrinkage.

Here, the material of the compact F need only be material for forming a solid having a desired shape, by hardening a liquid or a slurry in a mold. Here, a slurry is a fluid that includes solid particles. Some examples of this kind of material are metal material and injection molding material. Metal material includes steel, cast iron, aluminum, magnesium, copper, zinc, lead, tin, or an alloy of these, for example. Injection molding material includes thermosetting resin, thermoplastic resin, and rubber, for example.

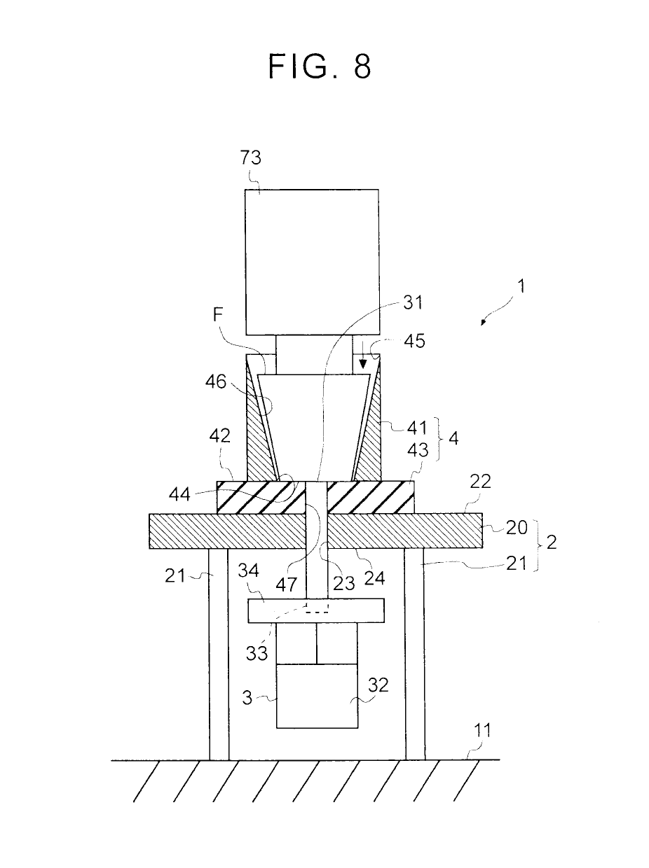

Next, a weight 73 is placed on the compact F, as shown in FIG. 8 (step S5). The compact F is baked onto the upper main surface 42 of the plate-like die 43. Here, the compact F further heat shrinks (i.e., thermally contracts), and a side surface of the compact F is formed separating from the inner wall surface 46.

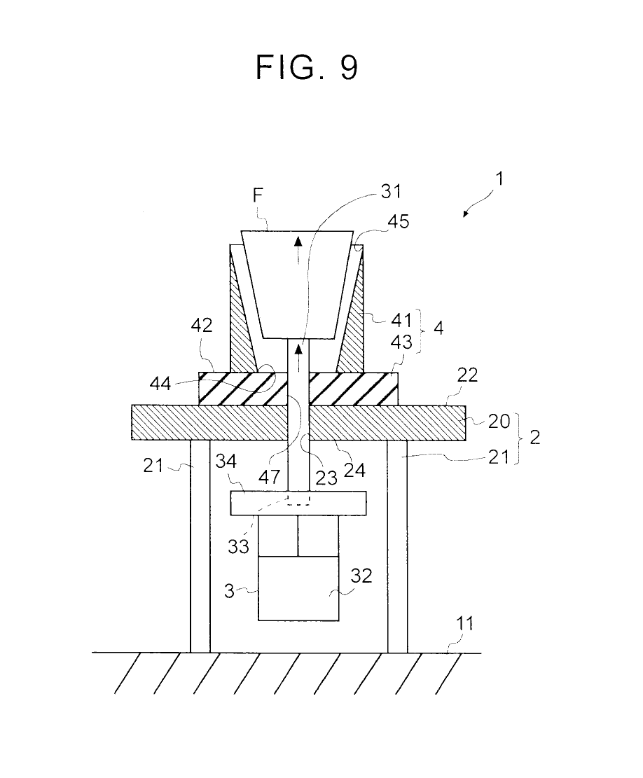

Finally, the weight 73 is removed from the compact F, and the extrusion pin 31 extrudes (i.e., pushes out) the compact F while the load measuring portion 33 measures the load applied to the extrusion pin 31, as shown in FIG. 9 (step S6). When this is done, the extrusion pin 31 receives a reaction force from the compact F, because the compact F is baked onto the plate-like die 43. Friction resistance force does not act between the compact F and the plate-like die 43. Also, the side surface of the compact F separates from the inner wall surface 46, so the cylindrical die 41 does not affect the reaction force on the extrusion pin 31 from the compact F. When the compact F continues to be extruded by the extrusion pin 31, the compact F separates from the plate-like die 43. The load measured at the time of this separation is the mold release resistance force. That is, the mold release resistance force is able to be measured without being affected by the friction resistance force or the cylindrical die 41. That is, the mold releasability evaluating apparatus 1 is able to measure the mold release resistance force with good accuracy.

The mold releasability evaluating apparatus according to the first example embodiment above makes it possible to measure the mold release resistance force with good accuracy.

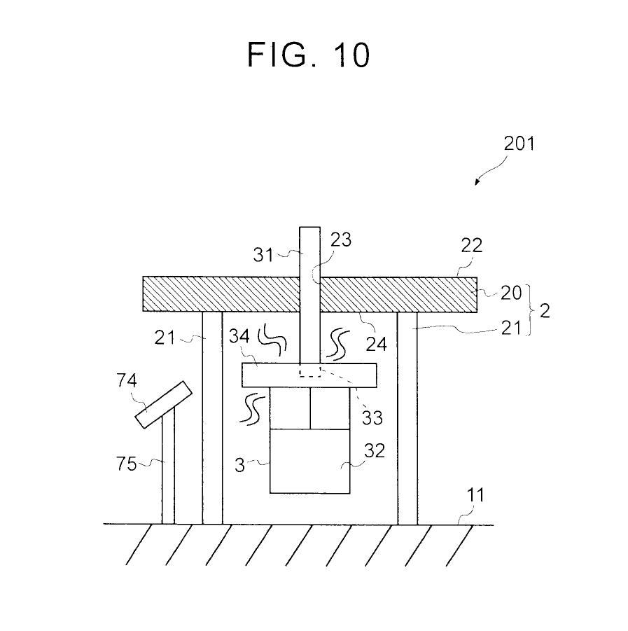

In the first example embodiment, the compact F is made to release from the compact F by making the extrusion pin 31 protrude, but ultrasonic vibration may also be added in addition to making the extrusion pin 31 protrude. For example, as shown in FIG. 10, a mold releasability evaluating apparatus 201 has the same structure as the mold releasability evaluating apparatus 1 according to the first example embodiment, with the addition of an ultrasonic vibrating portion 74. The position and orientation of the ultrasonic vibrating portion 74 are fixed by a support column 75 such that the ultrasonic vibrating portion 74 generates ultrasonic waves toward an area near the tip end of the extrusion pin 31. With this mold releasability evaluating apparatus 201, it is possible to measure the mold release resistance force when ultrasonic waves are generated. The forming die 4 is not shown in FIG. 10.

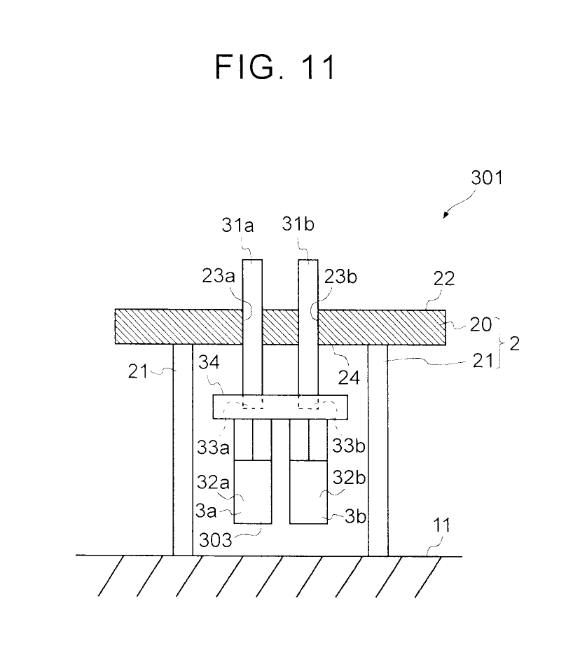

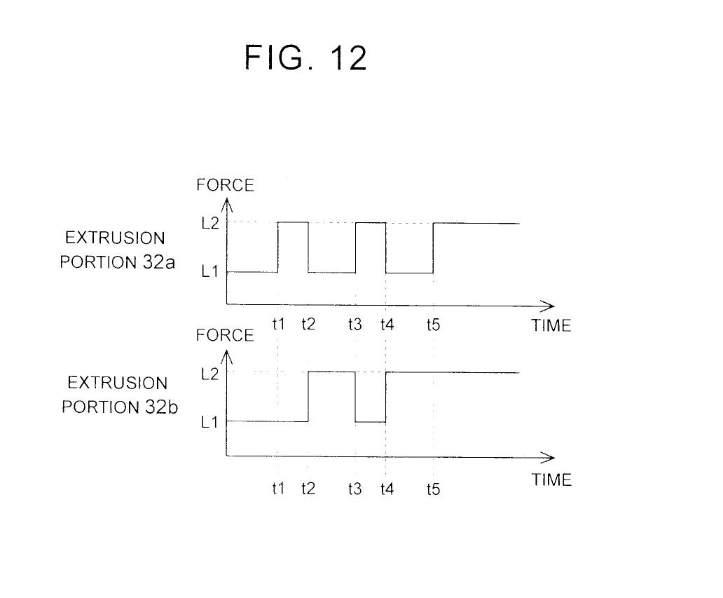

Also, in the first example embodiment, the compact F is released from the mold by making the extrusion pin 31 protrude, but two extrusion pins may also be made to protrude alternately. For example, as shown in FIG. 11, a mold releasability evaluating apparatus 301 has an extrusion mechanism 303 that differs from the extrusion mechanism 3 of the mold releasability evaluating apparatus 1 according to the first example embodiment. The forming die 4 is not shown in FIG. 11. The extrusion mechanism 303 of the mold releasability evaluating apparatus 301 includes extrusion pins 31a and 31b, and extrusion portions 32a and 32b. The extrusion pins 31a and 31b are made to protrude upward independently by the extrusion portions 32a and 32b, respectively. The extrusion pins 31a and 31b are able to protrude alternately, as shown in FIG. 12. More specifically, at time t1 to t2, the extrusion pin 31a protrudes with a force L2, and the extrusion pin 31b protrudes with a force L1. Then at time t2 to t3, the extrusion pin 31 a protrudes with the force L1, and the extrusion pin 31b protrudes with the force L2. At time t3 to t4, the extrusion pins 31a and 31b operate as they did at time t1 to t2, and at time t4 to t5, the extrusion pins 31a and 31b operate as they did at time t2 and t3. From t5 on, the extrusion pins 31a and 31b both operate with the force L2. As a result, the mold release resistance force when the extrusion pins 31a and 31b alternately protrude with a predetermined force is able to be measured.

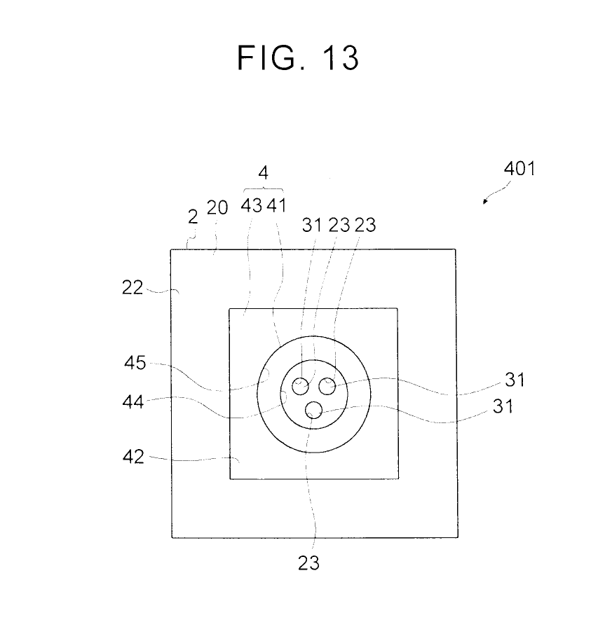

Also, in the first example embodiment, only one extrusion pin 31 is used, but a plurality of the extrusion pins 31 may also be used. For example, a mold releasability evaluating apparatus 401 has a structure similar to that of the mold releasability evaluating apparatus 1 according to the first example embodiment, except that it has three extrusion pins, as shown in FIG. 13. The three extrusion pins 31 operate by the same extrusion mechanism (not shown). As a result, the mold release resistance force when three extrusion pins are used is able to be measured.

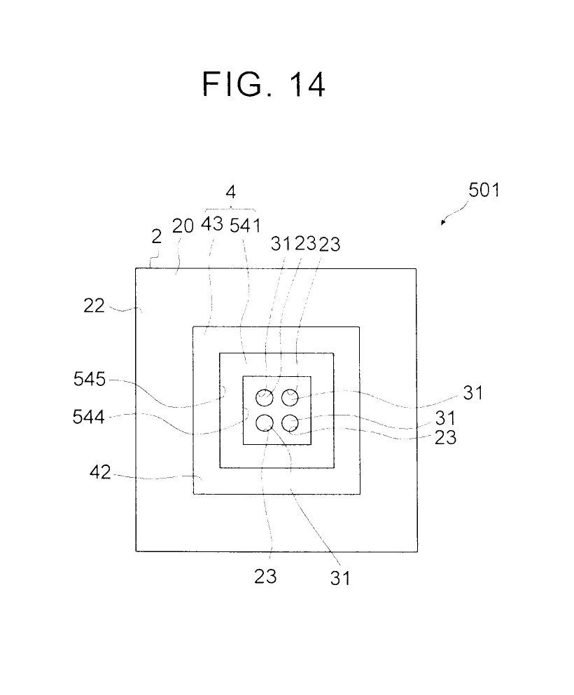

Also, in the first example embodiment, the cylindrical die 41 having a truncated cone shaped cavity is used, but a cylindrical die having a cavity of a different shape may also be used. For example, a mold releasability evaluating apparatus 501 has a structure similar to that of the mold releasability evaluating apparatus 1 according to the first example embodiment, except that four extrusion pins are used, and a cylindrical die 541 having a truncated quadrangular pyramid-shaped cavity is added instead of the cylindrical die 41, as shown in FIG. 14. As a result, the mold release resistance force when four of the extrusion pins 31 are provided and the cylindrical die 541 having a truncated quadrangular pyramid-shaped cavity is used is able to be measured.

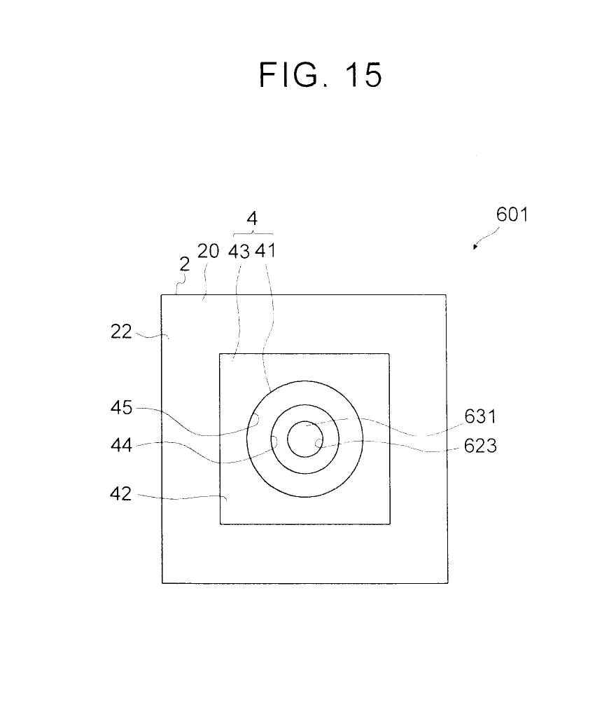

Also, in the first example embodiment, the extrusion pin 31 is used, but an extrusion pin having a different size diameter may also be used. For example, a mold releasability evaluating apparatus 601 has a structure similar to that of the mold releasability evaluating apparatus 1 according to the first example embodiment, with the addition of a large diameter extrusion pin 631 instead of the extrusion pin 31, as shown in FIG. 15. The large diameter extrusion pin 631 has a larger diameter than the extrusion pin 31 does. As a result, the mold release resistance force of the extrusion pin having a large diameter is able to be measured.

Also, in the first example embodiment, the load is measured using the load measuring portion 33, but sound produced at the time of mold release may be collected using a sound collecting portion. The sound collecting portion is arranged in a position and orientation that enables it to collect sound produced when the compact F is released from the mold. When the mold releasability evaluating apparatus 1 according to the first example embodiment has a sound collecting portion, it is possible to collect the sound produced when the compact F is released from the mold, and evaluate mold releasability based on this collected sound information. Furthermore, the mold releasability evaluating apparatus may be used in a laboratory, not a factory, so the sound produced when the compact F is released from the mold is able to be accurately measured in the relatively quiet environment of a laboratory as opposed to a factory. Also, compared to the mold releasability evaluating apparatus described in JP 2005-009971 A, the mold releasability evaluating apparatus according to the first example embodiment is able to output a louder sound when the compact is released from the mold, and is thus able to measure this sound with good sensitivity.

Further, in the first example embodiment, the load is measured by the load measuring portion, but a compact temperature measuring portion may also be provided and the temperature of the compact F measured. A radiation thermometer, for example, may be used as the compact temperature measuring portion. Compared to the mold releasability evaluating apparatus described in JP 2005-009971 A, the mold releasability evaluating apparatus having a compact temperature measuring portion is able to easily measure the temperature of the bottom surface of the compact F, and evaluate the heat insulating properties of the mold release agent and the sleeve lubricant based on this temperature.

Also, in the first example embodiment, the extrusion pin 31 is used, but an extrusion pin having any of a variety of shapes may be used. A stepped pin, for example, may also be used as the extrusion pin 31. As a result, the shape of the stepped pin is able to be evaluated.

Also, in the first example embodiment, the plate-like die 43 is used, but a pin may also be arranged extending upward on the upper main surface 42 of the plate-like die 43. As a result, the shape and material of the core pin, and the mold releasability of the surface treatment film are able to be evaluated.

What is claimed is:

1. A mold releasability evaluating apparatus comprising:
a forming die that includes a bottom portion having a main surface, and a wall surface portion that is connected to the main surface of the bottom portion and has a wall surface in which an angle formed with the main surface of the bottom portion is an obtuse angle;
an extrusion pin capable of protruding out from the main surface of the bottom portion in a direction that separates a compact from the main surface of the bottom; and
a measuring device configured to measure a load applied to the extrusion pin when the extrusion pin pushes the compact away from the main surface of the bottom portion, after one surface of the compact is formed by the main surface of the bottom portion.

2. A mold releasability evaluation method comprising:
a first step of forming, using the mold releasability evaluating apparatus according to claim 1, the one surface of the compact with the main surface of the bottom portion;
a second step of pushing the compact away from the main surface of the bottom portion by the extrusion pin; and
a third step of measuring the load applied to the extrusion pin in the second step.

3. The mold releasability evaluation method according to claim 2, further comprising:
a fourth step of separating the compact from the wall surface portion by the compact shrinking, between the first step and the second step.

4. The mold releasability evaluation method according to claim 2, further comprising:
a fifth step of applying a mold release agent to the main surface of the bottom portion before the first step.
